(19) United States
(12) Patent Application Publication
(10) Pub. No.: US 2014/0154658 A1
(43) Pub. Date: Jun. 5, 2014

(54) EDUCATIONAL APPLICATION GENERATOR AND EDUCATIONAL READER

(71) Applicants: Uri Kaplan, Haifa (IL); Rani Cohen, Tel Aviv (IL); David Zucker, Tel Aviv (IL); Dov Moran, Kfar Saba (IL)

(72) Inventors: Uri Kaplan, Haifa (IL); Rani Cohen, Tel Aviv (IL); David Zucker, Tel Aviv (IL); Dov Moran, Kfar Saba (IL)

(21) Appl. No.: 14/235,452

(22) PCT Filed: Jul. 30, 2012
(86) PCT No.: PCT/IL2012/000288

§ 371 Date: Jan. 28, 2014

Related U.S. Application Data
(60) Provisional application No. 61/513,587, filed on Jul. 30, 2011.

(51) Int. Cl. G06Q 50/20

(52) U.S. Cl. CPC G06Q 50/205
USPC 434/362

(57) ABSTRACT

A digital content reader for use with educational content and educational applications, including a content directory for storing digital books and interactive educational applications, a display, coupled with the content directory, for presenting the digital books for reading, and for presenting a user interface for operating the interactive educational applications, an activity log, coupled with the content directory and with the display, for storing a user's progress in reading the digital books and in operating the educational applications, a wireless communicator for communicating with a remote device over an intranet, a controller, coupled with the wireless communicator, for at least partially controlling operation of the digital content reader by the remote device, and a monitor, coupled with the wireless communicator and with the activity log, for reporting data stored by the activity log to the remote device. An application generator for creating educational applications is also described and claimed.

### FIELD OF THE INVENTION

The field of the present invention is educational application generators and educational digital readers for the classroom.

### BACKGROUND OF THE INVENTION

The classroom is full of interactive and spontaneous dynamics between the teacher and the students, which is very important for the learning experience. Pre-televised classes, for example, lack such dynamics, and as a result they are an ineffective substitute for the classroom. As it is now commonplace for students to own versatile mobile computing devices, computerized educational systems are evolving. Despite their ability to present rich content to the students, today's computerized systems lack the full dynamics of a conventional classroom.

Conventional educational systems that integrate tablet computers or eReaders are either offline or Internet-based. Offline systems use standalone tablet computers or eReaders, and have the drawback that they lack class management capabilities. Internet-based systems require continuous robust Internet connections. For schools, which have a large population of student and teacher users, Internet-based systems have the drawback that they require high speed Internet connections, which is expensive and may not be available.

Conventional tablet computers and eReaders, used as reading and learning devices in a classroom setting, have several drawbacks.

Teachers are not able to control their students' devices. Consequently, teachers are unable to manage their classes and monitor students' progress effectively. Teachers are not able to add content to existing textbooks, and share it with their students online. Teachers cannot generate and publish educational content adapted for tablet computers and eReaders. As such, elements of dynamic classroom education are lacking.

Students cannot communicate online with others who are reading the same material. Consequently, students are not able to form a joint learning session, mutually supporting one another.

### SUMMARY OF THE DESCRIPTION

Aspects of the present invention provide computerized educational systems that support the interactive and spontaneous dynamics of the conventional classroom.

Aspects of the present invention provide novel educational eReaders and educational application generators that overcome drawbacks of conventional classroom educational systems that use tablet computers or eReaders. Further aspects of the present invention provide class management tools and class monitoring tools, in conjunction with the educational eReaders and with the educational applications generated by the application generators.

In accordance with an embodiment of the present invention, a novel educational eReader, which uses wireless communication, operates in conjunction with class management tools and with class monitoring tools. The educational eReader enables teachers to add annotation layers to text, including inter alia comments, media, links, and highlights, and to push the layered text to their students. The educational eReader also enables teachers to monitor their students' progress. Use of the educational eReader requires only a low bitrate intranet connection. As such, the educational eReader may be used with a Wi-Fi router, and does not require an Internet connection.

The educational eReader provides offline reading. When an Internet connection is available, the educational eReader enables full connectivity. As such, when students use their educational eReaders outside of the classroom, they may enjoy social connectivity between others who are also using the educational eReaders of the present invention, and who may be working on the same educational material. Such social interaction promotes group learning and mutual support via text, voice and chat. The educational eReaders also interoperate with existing social networks such as FACEBOOK® and TWITTER®.

Further in accordance with an embodiment of the present invention, a novel educational application generator enables teachers to author and publish interactive educational applications. The educational application generator of the present invention is available both as a web service, and as installed software.

Educational applications generated by the educational generator may be published to educational eReaders. As such, these educational applications may be used in the classroom in conjunction with the class management tools and class monitoring tools of the present invention. These educational applications may also be used outside of the classroom, in a social connectivity environment for students.

There is thus provided in accordance with an embodiment of the present invention a digital content reader for use with educational content and educational applications, including a content directory for storing digital books and interactive educational applications, a display, coupled with the content directory, for presenting the digital books for reading, and for presenting a user interface for operating the interactive educational applications, an activity log, coupled with the content directory and with the display, for storing a user's progress in reading the digital books and in operating the educational applications, a wireless communicator for communicating with a remote device over an intranet, a controller, coupled with the wireless communicator, for at least partially controlling operation of the digital content reader by the remote device, and a monitor, coupled with the wireless communicator and with the activity log, for reporting data stored by the activity log to the remote device.

There is additionally provided in accordance with an embodiment of the present invention an application generator for creating educational applications, including a content editor for creating and editing interactive educational content, a scenario editor, coupled with the content editor, for generating a multi-stage educational application, each stage of which uses interactive educational content generated by the content editor, a mobile application generator, coupled with the scenario editor, for building a mobile application from the educational application generated by the scenario editor, for use on a wireless mobile device, and a web application generator, coupled with the scenario editor, for building a web-based application from the educational application generated by the scenario editor, for use with a web browser.

There is further provided in accordance with an embodiment of the present invention an educational system for classroom management, including a plurality of digital content readers, each digital content reader including a content directory for storing digital books and interactive educational applications, a display, coupled with the content directory, for presenting the digital books for interactive reading, and for presenting a user interface for operating the interactive educational applications, an activity log, coupled with the content directory and with the display, for storing a user's progress in reading the digital books and in operating the educational applications, and a wireless communicator for communicating with the other digital content readers over an intranet, and for communicating with a remote web server, an educational application generator for creating the educational applications, including a content editor for creating and editing interactive educational content, a scenario editor, coupled with the content editor, for generating a multi-stage educational application, each stage of which uses interactive educational content generated by the content editor, and a wireless communicator for communicating with the other digital content readers over an intranet, and for communicating with the remote web server, and a remote web server for storing the digital books and the educational application generated by the application generator, and for distributing the digital books and the educational applications to the digital content readers.

The following definitions are employed throughout the specification.
CLASS NETWORK—a network of educational eReaders that provides a classroom infrastructure.
CONTENT EDITOR—a component of the educational application generator for generating educational content.
COURSE EDITOR—a component of the educational application generator for generating an educational application that incorporates an author's design of an interactive course that teaches a subject using educational content.
COURSE SCENARIO EDITOR—a component of the course editor that generates the workflow of a multi-stage course, within conditional branching at various stages based on student progress and mastery of educational content.
EDUCATIONAL APPLICATION—an interactive application that runs on an educational eReader.
EDUCATIONAL APPLICATION GENERATOR—a tool for generating educational applications.
EDUCATIONAL EREADER—a computing device, such as a tablet computer or an IPAD® which is used to run interactive educational applications and to present interactive educational digital books.
STUDENT EREADER—an educational reader that functions as a student, within a class network.
TEACHER EREADER—an educational reader that functions as a teacher within a class network. There is at most one teacher eReader per class network.

### BRIEF DESCRIPTION OF THE DRAWINGS

The present invention will be more fully understood and appreciated from the following detailed description, taken in conjunction with the drawings in which:

FIG. 1 is a simplified block diagram of an architecture for an overall educational system, in accordance with an embodiment of the present invention;

FIG. 2 is a simplified screen shot of an educational eReader user interface for a teacher, in accordance with an embodiment of the present invention;

FIG. 3 is a simplified screen shot of an educational eReader user interface for a student, in accordance with an embodiment of the present invention;

FIG. 4 is a screen shot of a page being presented by an educational eReader, indicating annotations made by other students, other classmates who are online, students from other schools who are working on the same material, and the teacher being online, in accordance with an embodiment of the present invention;

FIG. 5 is a simplified block diagram of an architecture for an educational eReader, in accordance with an embodiment of the present invention;

FIG. 6 is a simplified screen shot of a content editor user interface for an educational application generator, in accordance with an embodiment of the present invention;

FIG. 7 is a simplified screen shot of a course scenario editor user interface for an educational application generator, in accordance with an embodiment of the present invention; and

FIG. 8 is a simplified block diagram of an architecture for an educational application generator, in accordance with an embodiment of the present invention;

FIG. 9 is a simplified screen shot of viewing a teacher's notes, in accordance with an embodiment of the present invention;

FIG. 10 is a simplified screen shot of accessing teacher and student comments, in accordance with an embodiment of the present invention;

FIG. 11 is a simplified screen shot of viewing a student roster showing which students have left a teacher's page, and showing a control for re-directing students back to the teacher's page, in accordance with an embodiment of the present invention; and

FIG. 12 is a simplified screen shot of tools used in an overall educational system, in accordance with an embodiment of the present invention.

### DETAILED DESCRIPTION

Aspects of the present invention relate to a novel educational eReader for use in the classroom by students and their teacher, and for use out of the classroom by students who wish to study together. The educational eReaders are operative to run classroom management tools that enable the teacher to interact with the students, and student monitoring tools that enable the teacher to monitor the students' progress. Aspects of the present invention also relate to a novel educational application generator for generating interactive educational applications for use with the educational eReaders.

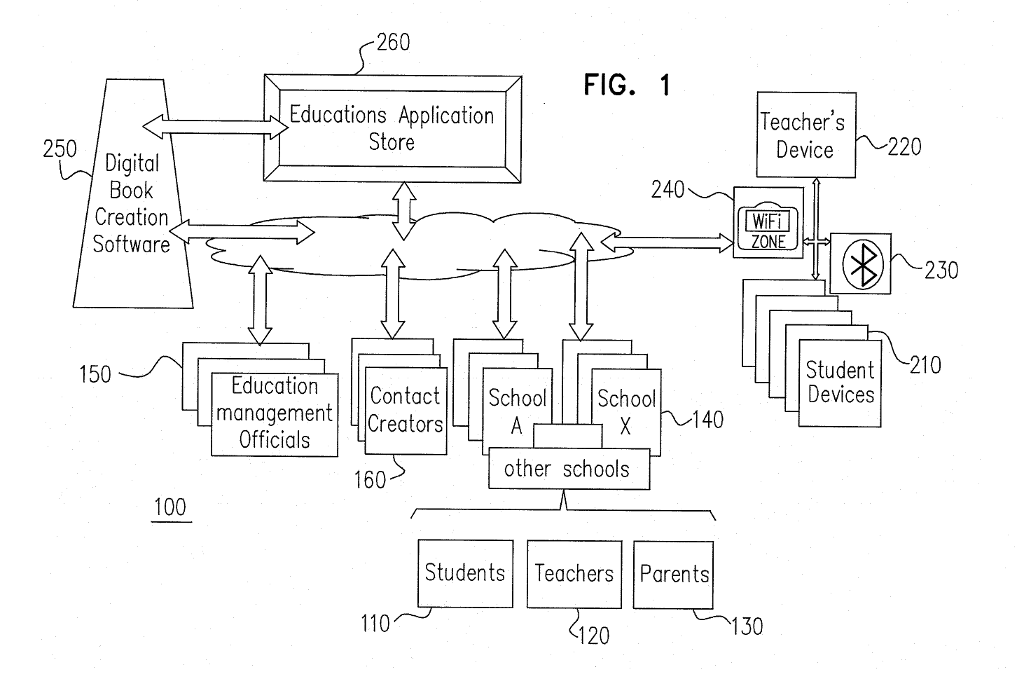

Reference is made to FIG. 1, which is a simplified block diagram of an architecture for an overall educational system 100, in accordance with an embodiment of the present invention. System 100 is accessed by schools 140, and by students 110, teachers 120 and parents 130 associated with the schools. System 100 is also accessed by educational management officials 150 and by educational content creators 160. Within system 100, student educational eReaders 210 and teacher educational eReaders 220 communicate wirelessly via a Bluetooth intranet 230 or a Wi-Fi intranet 240. A content creation software application 250 is used to author digital books and interactive educational applications for use by educational eReaders 210 and 220. An education application web store 260 distributes and markets the digital books and educational

applications authored by content creation software application 250.

System 100 enables an administrator of an organization, such as a school and a municipality, to assign books and other material to students, via an on-line tool. The administrator may select an individual book distribution plan for an individual student, or for a group of students such as students of a specific class, students of a specific school, or students of a specific age group. Individual student accounts for system 100 may be generated independently by the students, or an organization may subscribe to system 100 on behalf of a group of students. System 100 supports centralized purchasing of books and other material by individual students, or by a group of students registered with a subscribing organization.

A student may purchase all or a selected subsets of his assigned books and other material through system 100. Upon purchase of a book or other material, the book or other material is downloaded to the student's eReader, using secure encryption.

System 100 supports continuous book management. An administrator may delete books from student accounts, subject to authorization from the student.

### I. Educational Reader

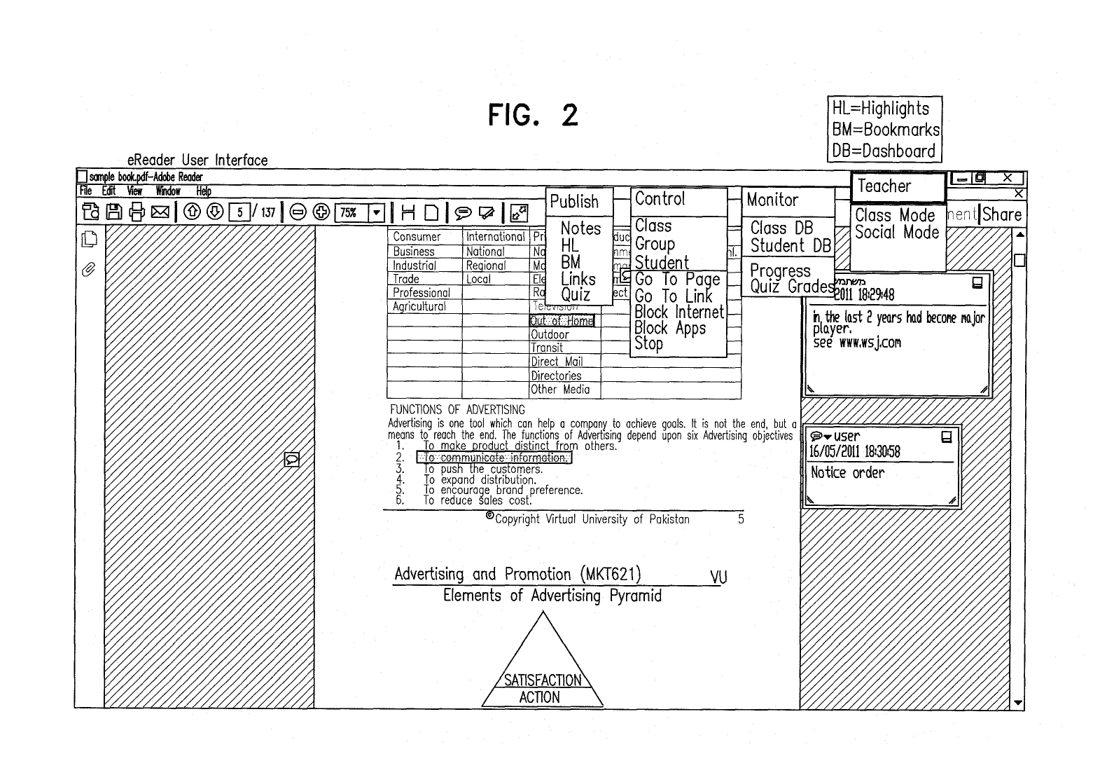

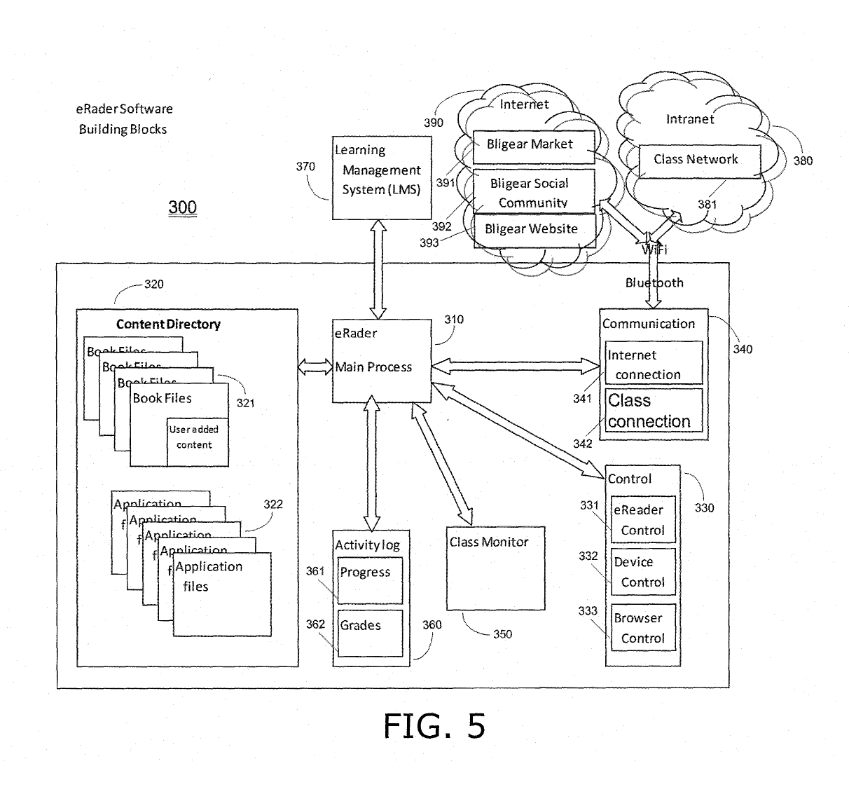

An embodiment of the educational eReader of the present invention is described hereinbelow through screen shots in FIGS. 2-4 and a block diagram in FIG. 5.

Educational eReaders connected to the same wireless Wi-Fi router, or connected via the Internet, form a class network. It is noted that an Internet connection is not required for enabling the class network. The class network is generated by one of the educational eReaders, designated as a teacher eReader, the other eReaders in the class network being designated as student eReaders. Student eReaders request registration to the class network, and their requests are transmitted to the teacher for approval. After initial setup of the class network, subsequent student registration may be automated, or may be manually activated by student sign-in.

### I.A Educational Reader: Teacher Control

The educational eReaders of the present invention enable teacher control of student eReaders.

The teacher eReader sends commands to other eReaders; either to a single student eReader, or to a group of student eReaders, or to an entire class of student eReaders. The student eReaders receive and process the commands sent by the teacher eReader. Commands sent by the teacher eReader include inter alia “go to a location in the textbook or in an educational application”, “go to an Internet link”, “open an educational application”, “close other applications”, “close Internet browsing” and “stop all work”. The teacher can issue two types of commands; namely, voluntary commands, in which case a dialog box appearing on the student eReader requests the student's approval to execute the command, and compulsory commands, in which case the command is automatically executed on the student eReader.

The student eReader, upon receiving a command from the teacher eReader via the class network, responds in accordance with the command being voluntary or compulsory, as indicated hereinabove. Commands related to an active running educational application are performed within the application. Commands related to other applications, such as an Internet browser, are performed by activating the other applications. Commands to close other applications, or to stop work on the educational eReader, are performed by an operating system of the educational eReader.

### I.B Educational Reader: Teacher Monitoring

The educational eReaders of the present invention enable teacher monitoring of student eReaders.

A student eReader logs a student's reading progress, as indicated by a time stamp in a textbook or in an educational application. The student eReader also logs the student's performance on quizzes. When the student works off-line, logged progress data is stored on the student eReader, and when the student eReader is subsequently connected to a class network the logged progress data may be transmitted to the teacher eReader. Alternatively, or additionally, when the student eReader is subsequently connected to the Internet, the logged progress data may be transmitted to a website, such as website 393 of FIG. 5, described hereinbelow.

### I.C Educational Reader: Sharing

The educational eReaders of the present invention enable sharing of information and material via the class network.

The class network enables sharing of notes, highlights, links, quizzes and other information between classmates, and between the teacher and the students. Shared information may be anchored to a specific location in a textbook or in an educational application, or stored on separate files.

Information may be presented as display overlays, including inter alia information layers for notes, highlights, links and bookmarks, and quiz layers. Quiz layers include a questions part and an answers part. The answers may be of various forms, including inter alia structured multiple choice options and fill-in answers, and unstructured answers. Multiple choice and fill-in answers may be provided for automated evaluation and feedback. Solutions to unstructured answers may be transmitted to the teacher eReader for evaluation.

### I.D Educational Reader: Social Networking

The educational eReaders of the present invention enable social interaction via the Internet.

The educational eReaders may connect to an Internet website to share information, to communicate, to post questions and answers, and to participate in online classes. Social interaction is preferably performed through the educational eReaders in conjunction with a common textbook or a common educational application being learned, and not through Internet browsers.

Students and teachers may discuss specific books. They may rank books, and rate educational applications and notes, thus generating crowd-based reviews.

### I.E Educational Reader: User Interface

Reference is made to FIG. 2, which is a simplified screen shot of an educational eReader user interface for a teacher, in accordance with an embodiment of the present invention. As shown in FIG. 2, the educational eReader may be used in the classroom in a class mode, and out of the classroom in a social mode.

As seen in FIG. 2, class management functionalities for teachers include the following operations.

“Publish”—for publishing layered annotations to students in the classroom.

“Notes”—for publishing notes on text, including inter alia text and images.

“Highlights”—for highlighting text in one or more highlight colors.

“Bookmarks”—for publishing bookmarks.

“Links”—for publishing hyperlinks to Internet web pages, anchored to designated text.

“Quiz”—for publishing quiz material, related to designated text. Teachers prepare quizzes and distribute them through the wireless intranet. Quizzes may be multiple choice or written answer. In the latter case, the written answers are uploaded to the teacher eReader at the end of the test, for the teacher to review and evaluate. Quiz results are sent to student eReaders over the web or in class.

“Control”—The teacher eReader can switch to a master/slave mode. In this mode the teacher eReader controls the student eReaders and determines which pages the students see. In this mode the students themselves cannot control their student eReaders.

“Class”—for controlling all educational eReaders in class.

“Group”—for controlling a specific group of educational eReaders.

“Student”—for controlling an individual student eReader.

“Go To Page”—in conjunction with “Class” or “Group” or “Student”, for directing all educational eReaders in a class, or a specific group of educational eReaders, or an individual student eReader, respectively, to a designated page in a textbook.

“Go To Link”—in conjunction with “Class” or “Group” or “Student” when an Internet connection is available, for directing all educational eReaders in a class, or a specific group of educational eReaders, or an individual student eReader, respectively, to a designated Internet link.

“Block Internet”—for blocking student eReaders from browsing the Internet.

“Block Apps”—for blocking student eReaders from accessing other applications, when a designated educational application is running.

“Stop”—for stopping work on student eReaders, such as at the end of a quiz, or when the teacher requires the students' attention.

“Monitor”—for monitoring students' progress, based on activity log data received from student eReaders. If reading assignments, or such other assignments, are administered to students, teachers can monitor in real-time which stage of an assignment each student is working on, and results of tests.

“Class Dashboard”—for monitoring the class.

“Student Dashboard”—for monitoring a student.

“Progress”—for monitoring class progress or student progress over time, based on progress reports received from student eReaders.

“Quiz Grades”—for viewing students' answers to questions on quizzes, including students' multiple choice selections.

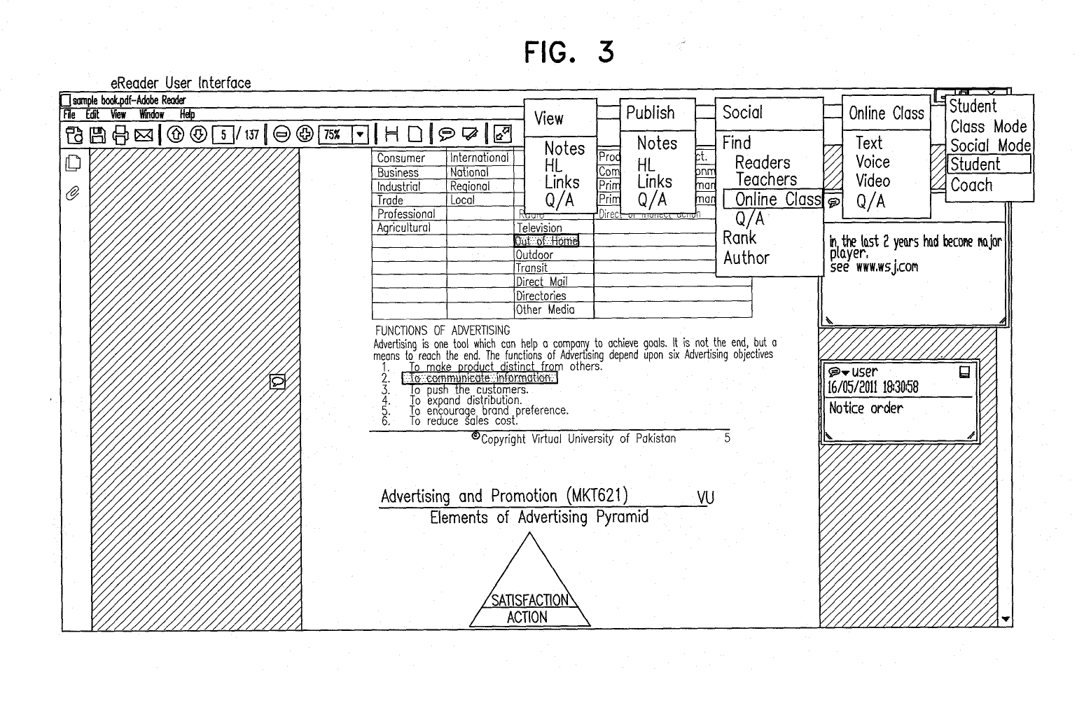

Reference is made to FIG. 3, which is a simplified screen shot of an educational eReader user interface for a student, in accordance with an embodiment of the present invention. As seen in FIG. 3, class management functionalities for students include the following operations.

“View”—for viewing data published by a teacher, as an annotation layer that can be toggled on and off.

“Notes”—for viewing notes on text, including inter alia text and images.

“Highlights”—for viewing highlighted text.

“Links”—for viewing hyperlinks to Internet web pages, related to designated text.

“Q/A”—for viewing questions and answers, related to designated text.

“Publish”—A student can annotate and mark his books with digital text or pen-like scribbling. The student can allow others to see his annotations, and can see his friends' annotations. A special graphic is displayed at words or paragraphs to indicate how many annotations are available, and the identities of the various annotators.

“Notes”—for publishing notes on text, including inter alia text and images.

“Highlights”—for publishing highlighted text in one or more highlight colors.

“Links”—for publishing hyperlinks to Internet web pages, anchored to designated text.

“Q/A”—for publishing questions and answers, related to designated text.

“Social”—for interacting socially with other users. Students can find other users from their class who are online with their educational eReaders, in real-time, and communicate with them via chat or VOIP in order to encourage collaborative work. Students can find students from other schools who are working on the same material, and communicate with them as well. Students can also find teachers on the network, and the teachers can make themselves available to their students during homework sessions.

“Find”—for finding a designated type of user.

“Readers”—for finding other educational eReaders that are on-line.

“Teachers”—for finding teachers who are on-line.

“Online Class”—for finding classmates who are on-line.

“Q/A”—for posting questions related to designated text, and for posting answers to questions.

“Rank”—for ranking an educational book or an educational application.

“Author”—for finding the author of a textbook or an educational application.

“Online Class”—for communicating with classmates.

“Text”—for transmitting text.

“Voice”—for transmitting voice.

“Video”—for transmitting video.

“Q/A”—for transmitting questions and answers.

“Class Mode/Social Mode”—for switching between class mode and social mode.

“Coach”—In social mode, a student may function as a coach, and initiate an on-line study session for a designated educational book or a designated educational applications. Participants may enroll in the session on-line. The coach may share his notes, highlights and links with the participants. The study session includes tools for an online Q/A session, for a VOIP conference session, and for a video conference session.

In some embodiments of the present invention, the educational eReader has one or more of the following additional features.

Educational eReaders are authenticated and enable students to obtain via a web store, using a single code, all of the books needed for the school year, without the need to browse for individual books. Books may be encrypted.

Digital books can incorporate questions at the end of each topic to ensure that students understand the subject matter. Point systems are operative to encourage students to answer questioners in order, and to ensure that they read the material. Students' performance and reading progress are collected and made available to their teachers and parents. Performance and progress statistics are available for other relevant parties, including inter alia content authors and education officials.

During class, a teacher eReader takes an automated roll call of all student eReaders present, and generates a list of students in class and a list of students that are missing.

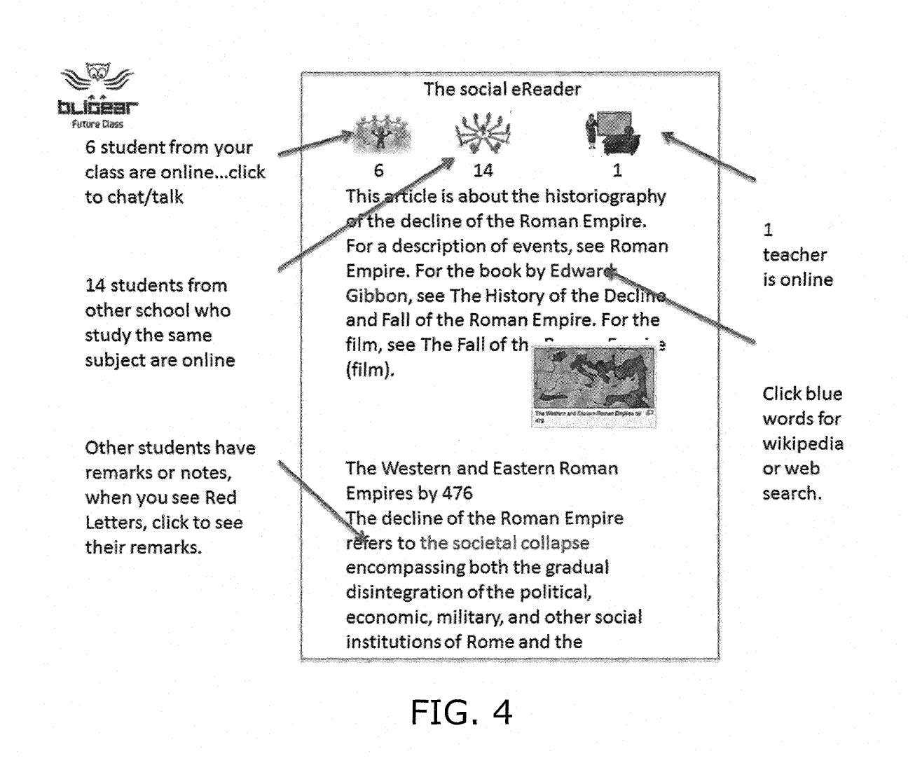

Reference is made to FIG. 4, which is a screen shot of a page being presented by an educational eReader, indicating annotations made by other students, indicating other classmates who are online, indicating students from other schools who are working on the same material, and indicating the teacher being online, in accordance with an embodiment of the present invention.

### I.F Educational Reader: Architecture

Reference is made to FIG. 5, which is a simplified block diagram of an architecture for an educational eReader 300, in accordance with an embodiment of the present invention. As shown in FIG. 5, educational eReader 300 includes six primary components; namely, a main process module 310, a content directory 320, a control module 330, a communication module 340, a class monitor module 350 and an activity log 360.

Content directory 320 includes files 321 for digital books, and files 322 for educational applications 322.

Control module 330 is used for controlling educational eReader 300 in the classroom by a remote teacher device. Control module 330 includes an educational eReader controller 331, a device controller 332 and a browser controller 333.

Communication module 340 supports wireless communication over an intranet 380 for a class network 381, using Bluetooth or Wi-Fi communication. Communication module 340 supports an Internet connection 341 and a class connection 342.

Activity log 360 includes a progress log 361, for monitoring students' progress, and a grades log 362, for recording students' grades.

Also shown in FIG. 5 is a learning management system 370; and Internet 390 with hosts for a market 391 for distributing and marketing digital books and educational applications, for a social community 392, and for a website 393 to which students' progress and grades are reported.

### II. Educational Application Generator

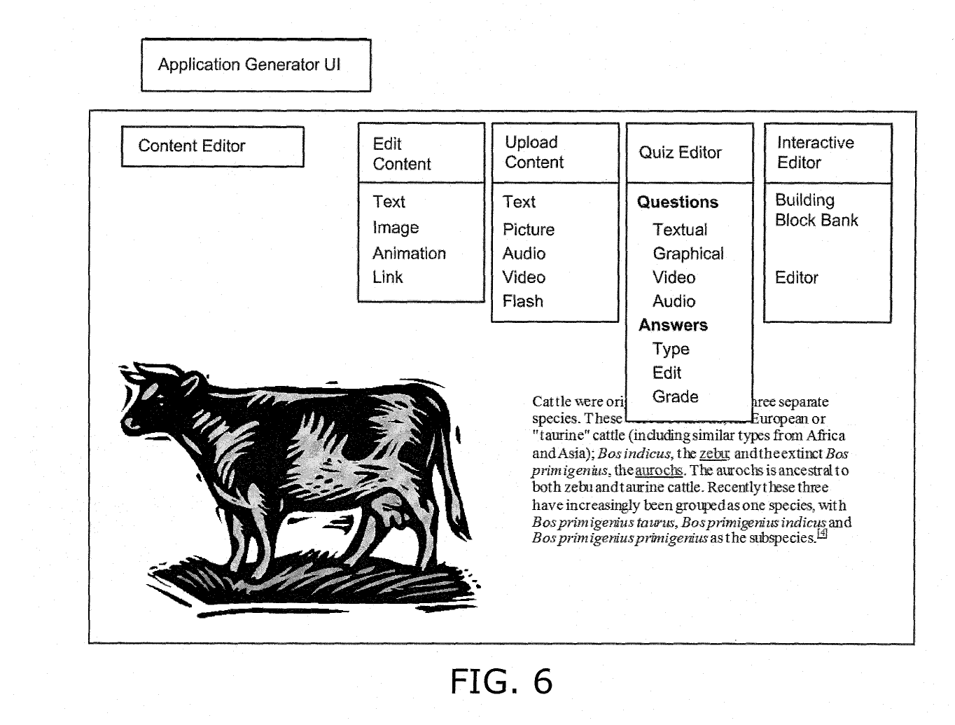

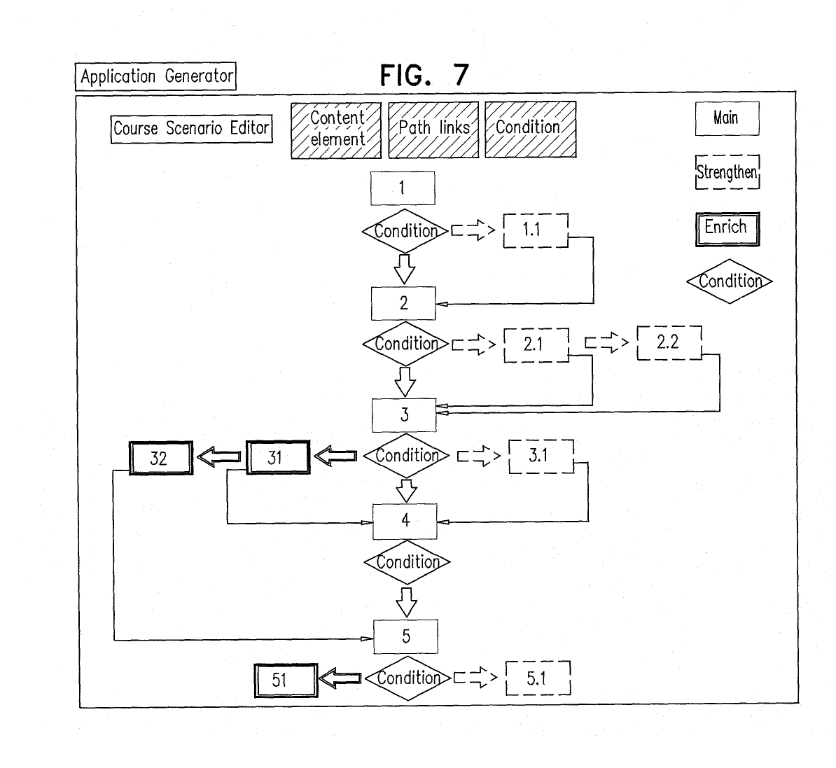

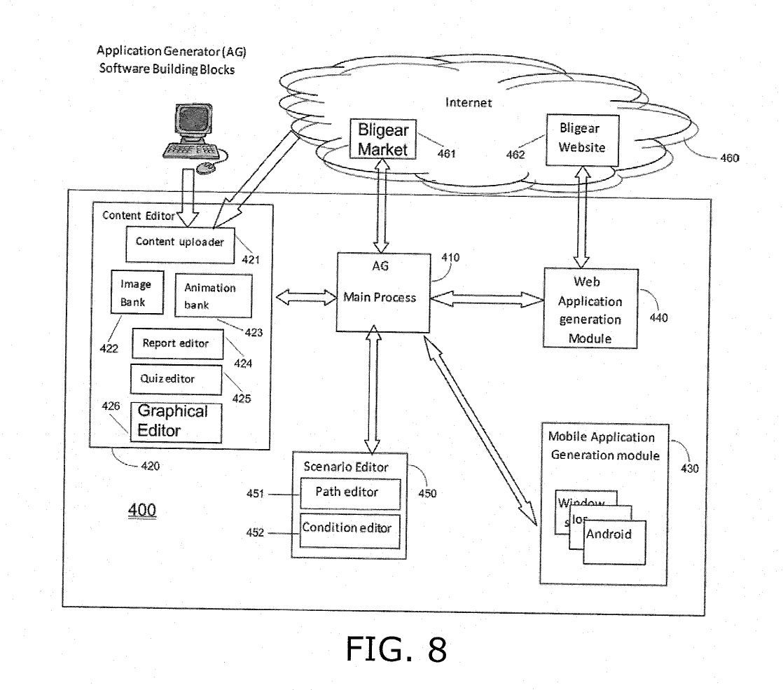

The educational application generator of the present invention may be embodied as a software package that enables students, teachers or other educators, to easily author interactive educational digital books and interactive educational applications. An embodiment of the application generator of the present invention is described hereinbelow through screen shots in FIGS. 6 and 7 and a block diagram in FIG. 8.

### II.A Educational Application Generator: Course Editor

The educational application generator of the present invention includes a course editor for course design, generation and editing. A course is packaged as an educational application, for use by educational eReaders.

The course editor operates on a web-based platform and on an application-based platform, which have a common user interface and common functionality. For the web-based platform, a course is designed by an author via a website. Access to the website is controlled by registration and login. Educational applications generated via the web-based platform are published on-line by a web market, such as market 461 of FIG. 8, described hereinbelow.

For the application-based platform, an author downloads and installs the course editor as a local application on his computer. Educational applications generated via the application-based platform are uploaded to the web market for publishing.

The course editor of the present invention includes a course scenario editor, which is used to generate a process workflow for a course. The process workflow may include conditional branches. As shown below in FIG. 7, the course scenario editor includes inter alia building blocks for content components, for logical condition components and for connectors. In accordance with an embodiment of the present invention, the course scenario editor includes template logical functions using grades or progress data as input; e.g., “if grade>90 then proceed to content element 3.1”.

### II.B Educational Application Generator: Content Editor

The educational application generator of the present invention includes a content editor for designing and generating content material for the content components of a course.

Each content component is reusable as a component in other courses. The content editor enables editing of text, image and link content; and uploading of text, image, audio, video and flash content. The content editor further enables generating quizzes, including questions, answers, grading and levels. The content editor further enables interactive editing of animations, from an existing compilation of interactive animations.

### II.C Educational Application Generator: Application Packager

The educational application generator of the present invention includes an application packager for packaging a designed course as an educational application. The educational application may be packaged as a file for local execution by an eReader, or as an on-line application.

For packaging a file, the author of the course selects a target operating system, such as Microsoft WINDOWS®, Google ANDROID® or Apple IOS®. Educational applications generated while on-line by the educational application generator are transmitted to a web market, such as market 461 (FIG. 8), and educational applications generated while off-line are subsequently uploaded to the web market.

On-line applications are made available via a web site, such as website 462.

### II.D Educational Application Generator: User Interface

Reference is made to FIG. 6, which is a simplified screen shot of a content editor user interface for an educational application generator, in accordance with an embodiment of the present invention.

The educational application generator is used to generate interactive educational applications that run on the educational eReaders. The educational applications may be mobile applications that run on any mobile operating system including inter alia Google ANDROID™, Apple IOS®, Microsoft WINDOWS MOBILE® 7, or any other such mobile operating system available now or in the future. The educational application generator may be embodied as a web-based service, as web-based software, or as a web-based application. An educational application generated by the educational application generator is published on a website for download, such as website 462 (FIG. 8), either for free or for a payment, a portion of which is paid to the author of the application and a portion of which is paid to the operator of the website.

As shown in FIG. 6, content editing functionalities for authors of educational applications include the following operations.

“Edit Content”—for authoring and editing content.

“Text”—for text editing.

“Image”—for graphics editing.

“Animation”—for animation editing.

“Link”—for link editing.

“Upload Content”—for uploading content and ingesting the content into an educational application.

“Text”—for uploading text.

“Picture”—for uploading an image.

“Audio”—for uploading an audio file.

“Video”—for uploading a video file.

“Flash”—for uploading a FLASH® presentation.

“Quiz Editor”—for editing questions of a quiz, and for generating multiple choice answers.

“Textual”—for editing text.

“Graphical”—for editing graphics.

“Video”—for editing video.

“Audio”—for editing audio.

“Type”—for designating a type of quiz.

“Edit”—for editing answers to a quiz.

“Grade”—for designating a formula for determining a grade for a quiz.

“Interactive Editor”—for generating and editing learning activities, including inter alia tasks and open questions.

“Building Block Bank”—for integrating activities from a pre-populated data bank of activities.

“Editor”—for generating and editing activities with the assist of basic building blocks.

In some embodiments of the present invention, the educational application generator has one or more of the following additional features.

The educational application generator may be embodied as a web-based application where text, pictures, links and tests are added. Markers are used to tag stages where student progress reports are transmitted to the teacher, thereby providing the teacher with feedback on students' performance.

The educational application generator enables authors to publish their books in the educational market, using a one-click. Authors can continuously improve their books based on the feedback they receive from students' performance.

Reference is made to FIG. 7, which is a simplified screen shot of a course scenario editor user interface for an educational application generator, in accordance with an embodiment of the present invention. The course scenario editor is a tool for course workflow design. As shown in FIG. 7, the course scenario editor includes content components, paths, and logical conditions for branching between content components.

Each rectangle in FIG. 7 represents a study chapter. There are three different types of chapters; namely, (i) main chapters, designated variously as “1”, “2”, “3”, “4” and “5” (ii) supplemental chapters for students experiencing difficulty, designated variously as “1.1”, “2.1”, “2.2”, “3.1” and “51”, and (iii) enrichment chapters for advanced students, designated variously as “31”, “32” and “51”. Supplemental chapters may include, for example, supplemental explanations and supplemental examples. Enrichment chapters may include, for example, material beyond the basic curriculum. Each diamond in FIG. 7 represents a decision branch, based on a condition related to students' performance including inter alia quiz grades and reading pace. Branching may also be activated by user intervention, whereby a student or a teacher requests a supplement or an enrichment.

The course scenario editor may be used to generate a linear course, whereby workflow progresses in a simple step-by-step path through content components. Alternatively, the content scenario editor may be used to generate a multi-path course, which adapts the workflow of the content components to a student's abilities.

### II.E Educational Application Generator: Architecture

Reference is made to FIG. 8, which is a simplified block diagram of an architecture for an educational application generator 400, in accordance with an embodiment of the present invention. As shown in FIG. 8, educational application generator 400 includes five primary components; namely a main process module 410, a content editor 420, a mobile application generation module 430, a web application generation module 440 and a scenario editor 450.

Content editor 420 includes a content updater 421, an image bank 422, an animation bank 423, a report editor 424, a quiz editor 425 and a graphical editor 426.

Mobile application generation module 430 generates applications for various mobile operating systems, including inter alia Microsoft WINDOWS MOBILE® 7, Apple IOS™ and Google ANDROID™.

Scenario editor 450 includes a path editor 451 and a condition editor 452.

An on-line market 461 serves to publish, via Internet 460, educational applications generated by educational application generator 400, and a web-site 462 serves to provide access, via Internet 460, to on-line educational applications generated by educational application generator 400.

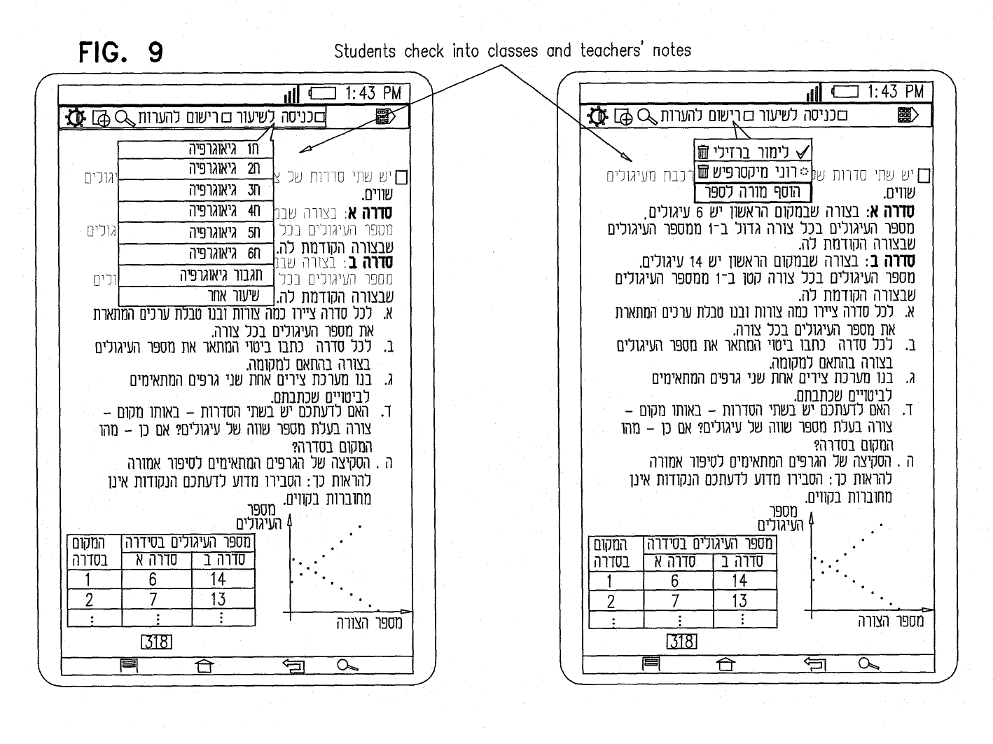

Reference is made to FIG. 9, which is a simplified screen shot of viewing a teacher's notes, in accordance with an embodiment of the present invention. Teachers can share their notes within with students of a class, with students of a school, or with students in an entire country. Teachers can also share their notes with other teachers via a teachers-only network.

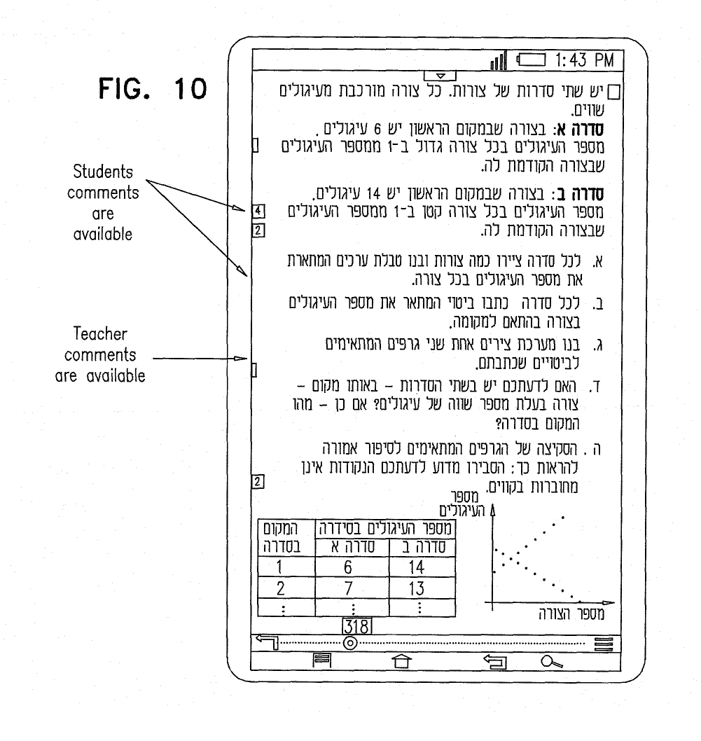

Reference is made to FIG. 10, which is a simplified screen shot of accessing teacher and student comments, in accordance with an embodiment of the present invention. Students can annotate comments and share them with other students and with their teacher. Students can share their comments with other students in their class, with other students in their school, and with other students within their entire country. Similarly, teachers can annotate comments and share them with others.

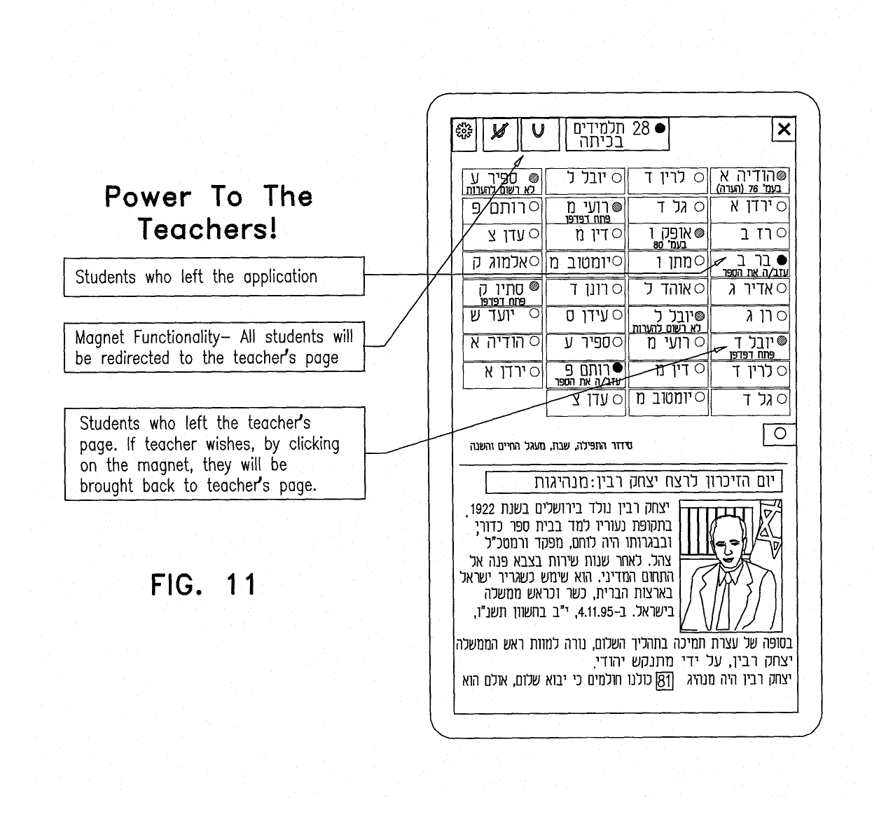

Reference is made to FIG. 11, which is a simplified screen shot of viewing a student roster showing which students have left a teacher's page, and showing a control for re-directing students back to the teacher's page, in accordance with an embodiment of the present invention. Each student's eReader registers itself automatically, or by manual checking-in to a class. A student may be registered via an IP address of his eReader, or via a GPS location. A teacher receives a roster all students participating in the class.

As shown in FIG. 11, a teacher can control the student eReaders by clicking on a “magnet” button, which draws all of the students' eReaders to a common location as specified by the teacher. The teacher may select a page or an application, and the entire class follows the teacher's selection.

A teacher may transfer control to a student eReader, in which case that student then controls the screens of the other students' cReaders. E.g., if that student writes on the screen or solves an exercise, the entire class sees what is done, creating an effect similar to writing on a smartboard with a projector.

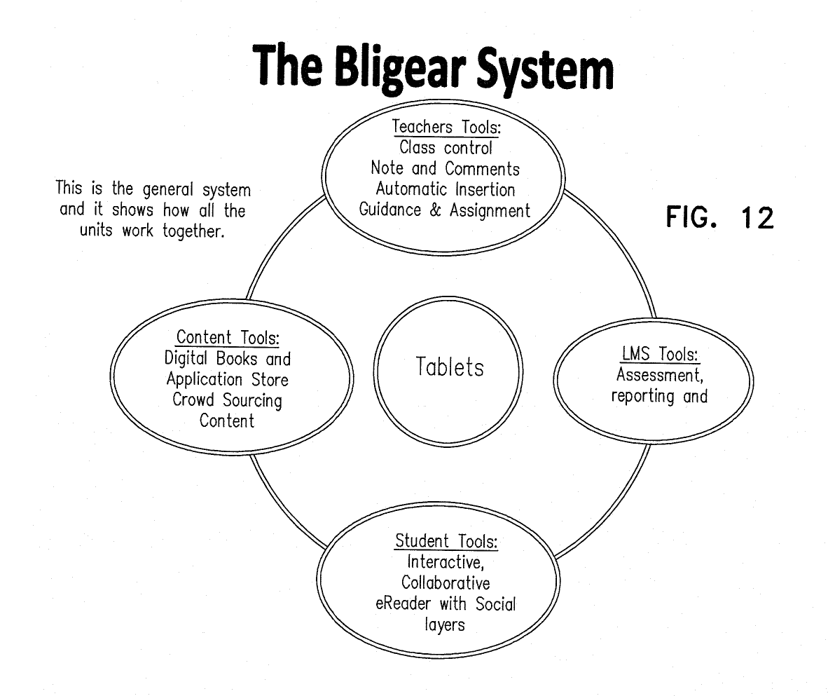

Reference is made to FIG. 12, which is a simplified screen shot of tools used in an overall educational system, in accordance with an embodiment of the present invention.

The present invention is not restricted to the field of education, and has broad application to a variety of classroom-like networks.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1-30. (canceled)

31. A digital content reader for use with educational content, comprising:
a content directory for storing digital books and accompanying test material therefor;
a display, coupled with said content directory, for presenting the digital books and their accompanying test material to a student;
an activity log, coupled with said content directory and with said display, for storing the student's progress and score in performing the interactive test material;
a wireless communicator for communicating with a remote teacher device over an intranet;
a controller, coupled with said wireless communicator, for at least partially controlling presentation of the digital books to the student on said display, in response to control instructions received from the remote teacher device; and
a progress monitor, coupled with said wireless communicator and with said activity log, for reporting data stored by said activity log to the remote teacher device.

32. The digital content reader of claim 31 wherein said controller receives a designation of a digital book and a portion thereof from the remote teacher device, and wherein, in response thereto, said controller presents the designated portion of the designated digital book to the student on said display.

33. The digital content reader of claim 31 wherein said controller receives annotation layers for portions of a designated digital book from the remove teacher device, and wherein, in response thereto, said controller toggles the annotation layers on and off when presenting the portions of the designated digital book to the student on said display.

34. The digital content reader of claim 31 further comprising an Internet web browser, and wherein said controller blocks use of said Internet web browser upon instruction from the remote teacher device.

35. The digital content reader of claim 31 wherein said wireless communicator is a BLUETOOTH® communicator or a Wi-Fi communicator.

36. The digital content reader of claim 31 further comprising an Internet browser for downloading the digital books and their accompanying test material, and for transmitting data stored by said activity log to a web server.

37. The digital content reader of claim 31 further comprising an attendance registrar operative to register the digital content reader with the remote teacher device at any given time.

38. The digital content reader of claim 37 further comprising a positioning system for identifying a current location of the digital content reader at the given time, and wherein said attendance registrar registers the current location with the remote teacher device.

39. An educational system comprising the digital content reader of claim 31, and further comprising a content generator for creating and publishing the digital books and their accompanying test material, the content generator comprising:
a content editor for creating and editing digital books and accompanying test material; and
an application publisher, coupled with said application generator, for transmitting the digital books and their accompanying test material, created and edited by said content editor, to said digital reader.

40. The educational system of claim 39 wherein said activity log reports receipt of the digital books and their accompanying test material to the remote teacher device.

41. The educational system of claim 39 wherein said content editor builds test material applications that are compatible with a mobile operating system from the group consisting of Microsoft WINDOWS MOBILE® 7, Apple IOS™ and Google ANDROID™.

42. The educational system of claim 39 wherein said content generator further comprises an Internet browser for uploading the digital books and their accompanying test material, created and edited by said content editor, to a remote web site.

43. An educational system for classroom management, comprising a plurality of networked student devices, each student device comprising a digital content reader in accordance with claim 31, and each digital content reader wireless communicator being operative to communicate with the other digital content readers via an intranet.

44. The educational system of claim 43 wherein the intranet via which said digital content readers communicate is a BLUETOOTH® intranet or a Wi-Fi intranet.

45. The educational system of claim 43 wherein said digital content reader wireless communicators enable multiple digital content readers to form and join a social network.

46. The educational system of claim 45 wherein each digital content reader comprises a discussion tool for sharing discussion of a digital book over the social network.

47. The educational system of claim 46 wherein said discussion tool enables each digital content reader within the social network to generate a rating of the digital book for sharing over the social network.

48. The educational system of claim 46 wherein said discussion tool enables a selected digital content reader within the social network to transmit annotation layers for portions of a designated digital book, for sharing over the social network, and wherein each digital content reader controller is operative to toggle the annotation layers on and off when it presents the portions of the designated digital book.

49. The educational system of claim 48 wherein the selected one of the digital content readers is selected by the remote teacher device.
